(19) United States
(12) Patent Application Publication
(10) Pub. No.: US 2009/0248218 A1
(43) Pub. Date: Oct. 1, 2009

(54) ENVIRONMENT CONTROL SYSTEM FOR A TRANSPORT UNIT

(75) Inventor: Allan Dyrmose, Bogense (DK)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 12/057,475

(22) Filed: Mar. 28, 2008

(51) Int. Cl. G05D 23/00

(52) U.S. Cl. 700/300

(57) ABSTRACT

An environment control system for a transport unit defining a cargo space. The environment control system comprises a controller in communication with a user interface such that the user interface identifies to the controller one kind of cargo within the cargo space, an environment adjusting system in communication with the controller and operable to regulate environment conditions inside the cargo space, and a database in communication with the controller for storing an environment profile as a function of the one kind of cargo such that the environment profile includes a plurality of environment control parameters, each environment control parameter controls the environmental adjusting system for a respective predetermined interval.

### BACKGROUND

The present invention relates to a transport unit that defines a space for storing and transporting cargo, and an environmental control system that controls a temperature of the cargo. More particularly, the present invention relates to an environment control system for a transport unit that controls conditions of a space of the transport unit based on predetermined parameters.

Generally, transport vehicles (e.g., straight trucks and tractor-trailer combinations) are used to transport temperature sensitive cargo that is maintained at predetermined conditions using a refrigeration unit during transportation to preserve the quality of the cargo. The cargo is transported, stored, or otherwise supported within a cargo space of the transport vehicle.

Often, the refrigeration unit is controlled by a temperature control unit. In some transport units, the temperature control unit includes a simple thermostat that turns the refrigeration unit on and off based on a single environmental condition (i.e., the desired temperature of the cargo space, or the setpoint temperature) to regulate the condition of the cargo space. An operator sets the thermostat to the desired setpoint temperature, and the thermostat controls the refrigeration unit to maintain the temperature of the space near the setpoint temperature. These existing thermostats are manually adjusted when a different setpoint temperature is desired.

### SUMMARY

In one embodiment, the invention provides an environment control system for a transport unit defining a cargo space. The environment control system comprises a controller in communication with a user interface such that the user interface identifies to the controller one kind of cargo within the cargo space, an environment adjusting system in communication with the controller and operable to regulate environment conditions inside the cargo space, and a database in communication with the controller for storing an environment profile as a function of the one kind of cargo such that the environment profile includes a plurality of environment control parameters and each environment control parameter controls the environmental adjusting system for a respective predetermined interval. The controller retrieves the environment profile for the one kind of cargo from the database based on the identified cargo communicated to the controller and delivers the plurality of environment control parameters of the environment profile to the environment adjusting system. The environment adjusting system is configured to then regulate one of the environment conditions inside the cargo space based on each environment control parameter received from the controller such that the environment control parameters control the environment adjusting system sequentially of one another based on the predetermined intervals.

In another embodiment the invention provides a method for transporting cargo in a cargo space within a transport unit, the method comprising the steps of providing a controller coupled to an environment adjusting system, identifying the cargo to the controller and identifying an environment profile associated with the cargo, the environment profile defining a plurality of environment control parameters for regulating one environment condition as a function of the cargo. The method further comprising the steps of sensing an environment condition within the cargo space, comparing the sensed environment condition with one of the desired environment control parameters provided by the environment profile, and modifying the environment condition with the environment adjusting system to achieve the one desired environment control parameter. The method further comprising the steps of comparing the sensed environment condition with another one of the desired environment control parameters provided by the environment profile after a predetermined interval, and modifying the environment condition with the environment adjusting system from the one desired environment control parameter to another one of the desired environment control parameters.

Other aspects of the invention will become apparent by consideration of the detailed description and accompanying drawings.

### BRIEF DESCRIPTION OF THE DRAWINGS

FIG. 1 is a side view of a transport vehicle including a transport unit defining a cargo space according to an embodiment of the present invention.

FIG. 2 is a schematic view of the transport unit of FIG. 1, including an environment adjusting system and a control unit having a database.

FIG. 3 is a front view of a portion of the control unit of FIG. 2, including a display screen and a keypad.

FIG. 4 is a front view of another display screen of the control unit of FIG. 2.

FIG. 5 is a schematic view of the database of the control unit of FIG. 2, including environment profiles for different cargo.

FIG. 6 is a schematic view of environment profiles of FIG. 5, including associated environment control parameters related to one type of cargo.

FIG. 7 is a flow diagram of an environment profile selection process for cargo located in the cargo space of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

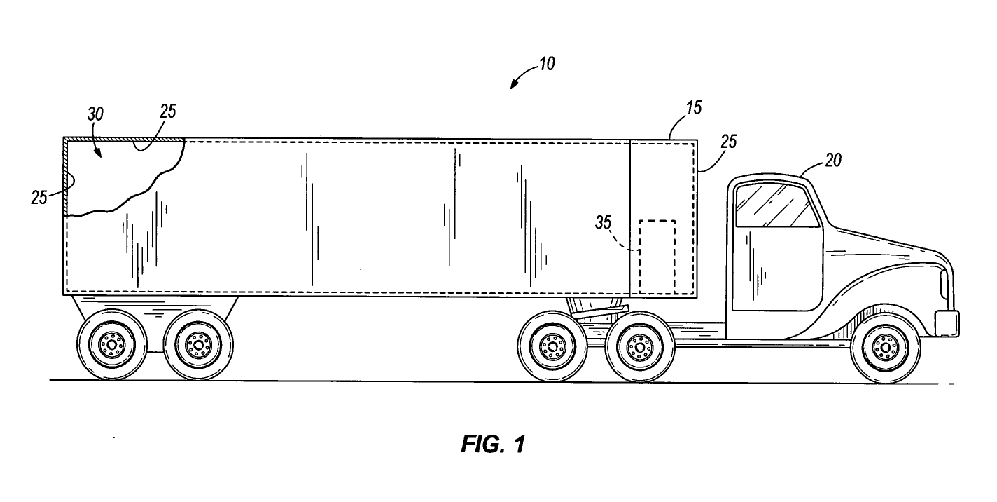

FIG. 1 shows a transport unit 10 that is suitable for storing and transporting perishable types of cargo (e.g., food, agricultural goods, or medical supplies, etc.) that are preferably be maintained at predetermined environmental conditions. The illustrated transport unit 10 is a tractor 15 that is coupled to a vehicle 20 for shipping perishable cargo in a tractor-trailer combination. In other constructions, the transport unit 10 can be the cargo container of a straight truck, van, or other similar vehicle that transports temperature-sensitive goods. In still other constructions, the transport unit 10 can include a free-standing shipping container or an air cargo container. Hereinafter, the term “transport unit” shall be used to represent all such containers and trailers, and shall not be construed to limit the invention's application solely to a trailer in a tractor-trailer combination.

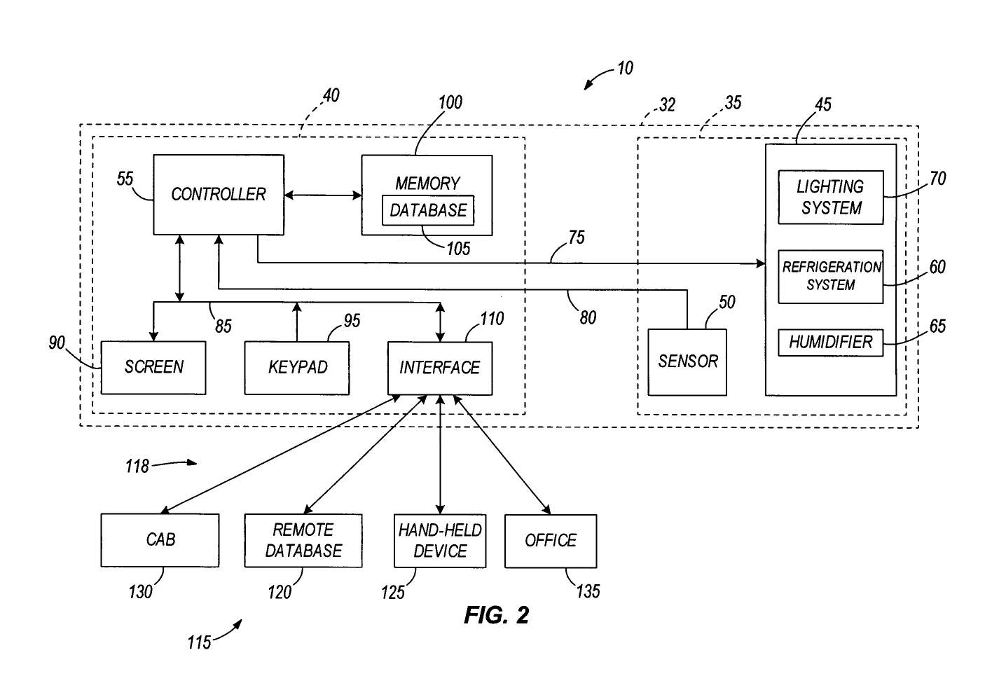

The transport unit 10 includes transport walls 25 that cooperate to define a cargo space 30. The transport unit 10 also includes an environment control assembly 32 (FIG. 2) that has an environment control system 35 located adjacent a front portion of the transport unit 10, and a control unit 40 (FIG. 2). In other constructions, the environment control system 35 can be located elsewhere in the transport unit 10. The environment control system 35 is in communication with the cargo space 30 to maintain the cargo space 30 at predetermined environment conditions (e.g., temperature, humidity, light etc.) during transportation and storage of the cargo in order to preserve the quality of the cargo.

FIG. 2 shows that the environment control system 35 includes an environment adjusting system 45 that regulates environment conditions (e.g., temperature, humidity, etc.) of the cargo space 30 in the transport unit 10, and a sensor 50 that is in communication with the cargo space 30 to measure environment conditions inside the cargo space 30 and to generate signals indicative of the environment conditions. The sensor 50 can be located anywhere in the transport unit 10 so that the sensor 50 is in communication with the cargo space 30. In some constructions, the environment control system 35 may include multiple sensors 50 that measure environment conditions inside the cargo space 30.

With continued reference to FIG. 2, the environment adjusting system 45 includes a refrigeration system 60, a humidifier 65, and a lighting system 70. Each of the refrigeration system 60, the humidifier 65, and the lighting system 70 are defined as an environment adjusting subsystem of the environment adjusting system 45. Each environment adjusting subsystem 60, 65, 70 is in communication with the cargo space 30 to regulate environment conditions of the cargo space 30 based on associated predetermined environment conditions. More particularly, each subsystem 60, 65, 70 performs one or more functions that regulate environmental conditions of the cargo space 30. For example, the refrigeration system 60 conditions air entering the cargo space 30, and can be operated continuously, or alternatively, for a predetermined time interval (e.g., start-stop mode). The refrigeration system 60 also is operable at one or more refrigeration capacities (fan speed, compressor speed, etc.) that are determined based on the needs of the cargo space 30. The subsystems 60, 65, 70 illustrated in FIG. 2 are exemplary subsystems of the environment adjusting system 45. In some constructions, the environment adjusting system 45 can include fewer than three subsystems. In other constructions, the environment adjusting system 45 can include more than three subsystems that independently or cooperatively regulate a particular environment condition of the cargo space 30 (e.g., a heater, a dehumidifier, an atmosphere regulator, a venting system, an air filtration system, an air sterilization system, etc.).

The control unit 40 includes a controller 55, a screen 90, a keypad 95, a memory 100, and a communication interface 110. The controller 55 is in communication with the subsystems 60, 65, 70 via a first communication channel 75, and is also in communication with the sensor 50 via a second communication channel 80 to receive the signal or signals indicative of the environment conditions of the cargo space 30 from the sensor 50. The controller is further in communication with the screen 90, the keypad 95, the memory 100, and the communication interface 110 via a communication bus 85. In some constructions, the control unit 40 can include other input/output devices. As described in detail below, a user or operator of the transport unit 10 can interact with the controller 55 through the screen 90, the keypad 95, and/or the communication interface 110.

The memory 100 can be defined by any suitable computer-readable medium for storing instructions that may be executed by the controller 55. For example, the instructions may be stored in a machine or computer system on any machine-readable medium, (e.g., a magnetic disk or optical drive, etc.), or alternatively, may be stored within non-volatile memory (e.g., read-only memory (ROM), etc.).

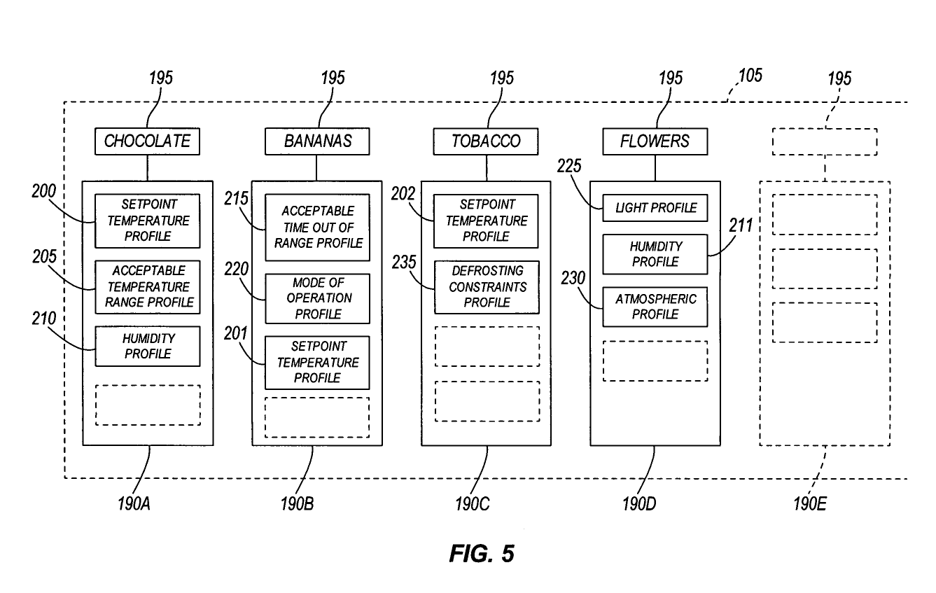

As illustrated in FIG. 2, the memory includes a database 105 that is in communication with the controller 55. In the illustrated construction, the database 105 is subsumed in or part of the memory 100. In other constructions, the database 105 may be external from the memory 100, or a part of the controller 55. The database 105 stores environment profile sets 190 (FIG. 5) as a function of particular cargo (e.g., chocolate, ice cream, apples, soft drinks, etc.). Each environment profile set 190 includes at least one environment profile that contains multiple environment control parameters that can be used by the controller 55 to regulate the environment adjusting system 45.

The communication interface 110 is in communication with a plurality of external access modules 115 via communication connections 118. In some constructions, the control unit 40 may include more than one communication interface 110. In the illustrated construction, the communication connections 118 communicate with the external access modules 115 wirelessly (e.g., radio frequency signal, infrared signal, satellite link, cellular telephone, etc.). In other constructions, the communication connections 118 may be hard-wired to the external access modules 115 (e.g., electrically or optically, etc.). The illustrated external access modules 115 include a remote database 120, a hand-held device 125, a cab 130 of the vehicle 15, and a shipping office 135. Other external access modules 115 (e.g., bar code scanner, optical character recognition scanner, etc.) can also be linked to the communication interface via a communication connection 118. The control unit 40 can obtain access to the remote database 120 via the communication interface 110 and one of the communication connections 118 to obtain data related to the cargo and the associated environment profile set 190.

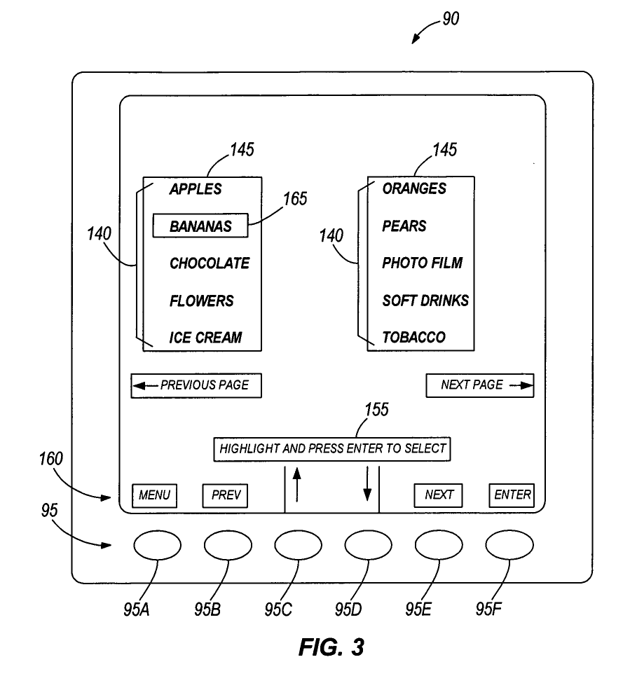

With reference to FIGS. 2-4, the user communicates the cargo to be hauled by the transport unit 10 to the controller 55 via the display screen 90 and the keypad 95, or alternatively, one of the external access modules 115. As shown in FIG. 3, the display screen 90 includes menus 145 and the keypad 95. The user may identify, for example, cargo such as “Chocolate” or “Tobacco,” by making a selection from one of the menus 145. The controller 55 receives a signal indicative of the cargo identification that corresponds to the cargo to be stored in the cargo space 30. After the controller 55 receives the signal indicative of cargo identification, the controller 55 retrieves the environment profile set 190 that is a function of the identified cargo from the database 105, or alternatively, the remote database 120. The controller 55 regulates the environment adjusting system 45 to appropriately condition the cargo space 30 based upon the retrieved environment profile set 190.

The display screen 90 and the keypad 95 may be coupled to the controller 55 via the bus 85 (FIG. 2). The display screen 90 may be a monochromatic display, or alternatively, a color display (e.g., a liquid crystal diode display, etc.) that is capable of displaying alphanumeric and graphic data. As shown in FIG. 3, each menu includes five cargo selections 165 displayed on the display screen 90. The cargo options 140 listed in each menu 145 may be arranged alphabetically, or alternatively, the cargo selections may be arranged in any other convenient way. For example, the cargo selections can be listed by categories of related products (e.g., “Frozen foods”, “Produce”, “Non-foods”, etc.), with sub-menus for each category. Sub-menus may also be provided for particular products. For example, after selection of the cargo option “Apples”, a sub-menu can be displayed that shows varieties of apples (e.g., “Delicious”, “Mcintosh”, “Granny Smith”, etc.). The menus 145 and other on-screen information may be presented in any language.

In constructions of the display screen 90 that include large menus 145, an index may be presented to allow the user to select a cargo option 140 using the first letter of the cargo option 140. In some constructions, the display screen 90 can include on-screen assistance 155. The user makes selections on the display screen 90 using the keypad 95. The keypad 95 includes a plurality of keys 95A-F. Each key 95A-F corresponds to and is associated with different actions 160 shown on the display screen 90. By pressing the appropriate keys, the user can move a selection area 165 from cargo option 140 to cargo option 140 and may access other lists of cargo options 140 on the menu 145. When the user's selection is highlighted by the selection area 165, the user may press the appropriate key 95 (e.g., “Enter” key 95F), which identifies the cargo and which is received by the controller 55.

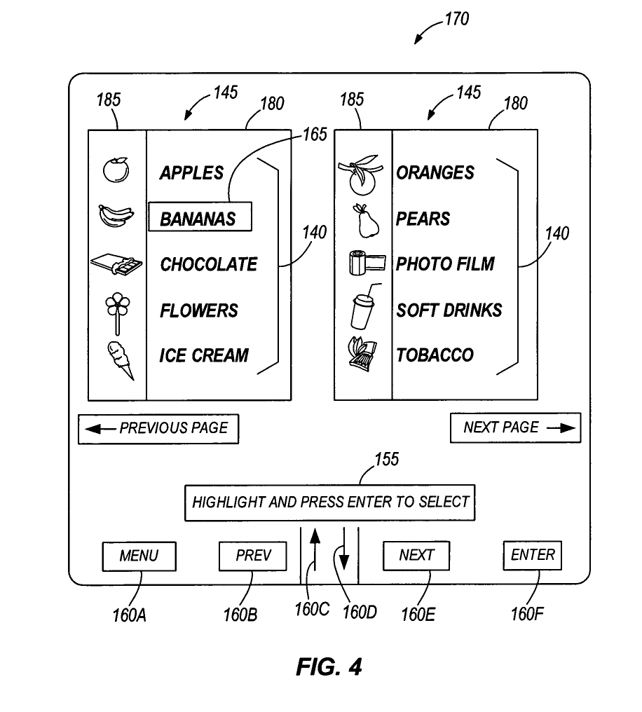

FIG. 4 shows another display screen 170 for the control unit 40. The display screen 170 includes menus 145, and each menu 145 has a script portion 180 and a graphical portion 185. In this construction, cargo options 140 can be displayed using written word representations of the associated cargo 180 using the script portion 180 and/or graphical representations using the graphical portion 185. The graphical portion 185 can include animations, photographs or other symbols that convey the cargo selection accurately. In some constructions, the cargo selections can be associated with other media representations. As used herein, the term “media representations” includes all forms of communication by which the cargo selections can be presented other than written word representations, (e.g., audio representations, icons, photographs). Media representations of the cargo assist the user with selecting the appropriate cargo. The control unit 40 can be arranged to present any media representations, graphical and/or written word representations alone or in combination with other to convey the cargo selections.

The display screen 170 illustrated in FIG. 4 is similar to the display screen 90 illustrated in FIG. 3, except that the display screen 170 is a touch screen that is without a separate keypad. In other words, the keypad is incorporated into the display screen 170, and the user selects the cargo simply by touching the screen 170. By touching the desired cargo selection, the desired cargo selection 165 is highlighted. For example, when the user touches the screen 170 in the area indicating the cargo selection for “BANANAS,” the “BANANAS” cargo option 140 is highlighted with the selection area 165. The user can then press the appropriate action key 160 (e.g., “Enter” key 160F) to continue identification of the cargo and the associated environment profile.

In some constructions, other input/output devices can be used to select a particular cargo. For example, a user in the office 135 can use a personal computer that displays the cargo options 140 to identify the cargo. The computer display can display the menu, and a keyboard or mouse can be used to enter the desired cargo option 140.

FIG. 5 shows that the database 105 includes a plurality of environmental profile sets 190 that are a function of the associated cargo 195. Each environment profile set 190 has at least one environment profile. For example, the environment profile set 190A includes a setpoint temperature profile 200, an acceptable temperature range profile 205, and a humidity profile 210. Other environment profiles are also possible, and are considered herein. The cargo 195 represents the products that can be hauled in the transport unit. Four types of cargo are illustrated in FIG. 5, although other types of cargo also can be stored in the database 105. The controller 55 retrieves the environment profile set from the database based on the cargo 195 identified by the user.

Multiple predetermined environment control parameters for each environment condition are programmed into the database 105 as an environment profile associated with a particular type of cargo. The environment profiles (e.g., setpoint temperature profile 200, humidity profile 210, etc.) can be provided by any authorized individual, including a supplier and/or a vender. Generally, the environment profiles are pre-programmed into the control unit 40 to expedite the selection of a particular cargo by the user. The controller 55 retrieves the associated environment profiles (i.e., the environment profile set 190) for the identified cargo and regulates the conditions of the cargo space 30 based on the predetermined environment control parameters.

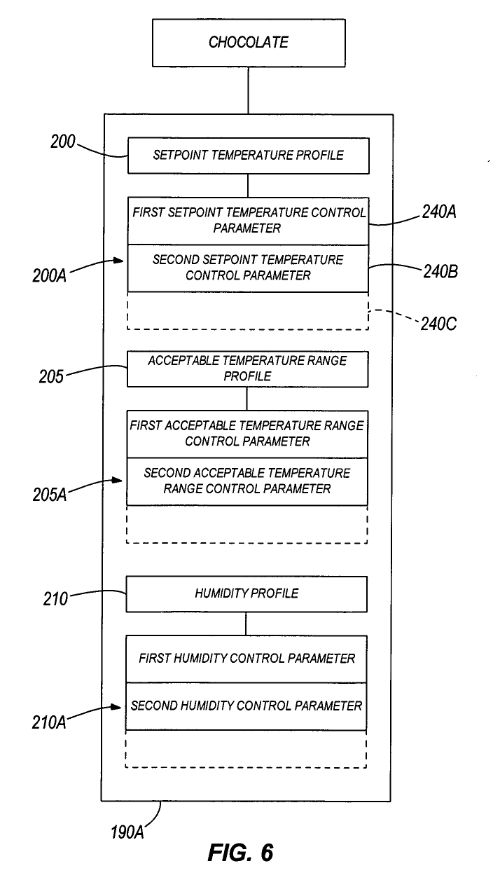

FIG. 5 shows several environment profile sets 190 for different cargo 195, including “CHOCOLATE.” FIG. 6 is a schematic of the environment profile set 190A for the cargo “CHOCOLATE” that is stored in the database 105. The selection of the cargo “CHOCOLATE” is exemplary, and one of ordinary skill in the art understands that other environment profile sets 190 associated with other cargo 195 can have the same or different environment profiles depending on the type of cargo and the parameters of the cargo space 30 that are to be regulated.

The environment profile set 190A includes a setpoint temperature profile 200, an acceptable temperature range profile 205, and a humidity profile 210. The setpoint temperature profile 200 has predetermined setpoint temperature control parameters 200A (e.g., a first setpoint temperature control parameter 240A, a second setpoint temperature control parameter 240B, etc) that regulate the temperature of the cargo space 30 for the duration that the cargo is stored in the transport unit 10. Some types of cargo are shipped at one relatively constant temperature. Accordingly, the setpoint temperature profile 200 may have only one environment control parameter (e.g., the first setpoint temperature control parameter 240A). For example, frozen beef may be shipped at a relatively constant temperature of about 5 degrees Fahrenheit (−15 degrees Celsius), while bananas may be shipped at a relatively constant temperature of about 54 degrees Fahrenheit (12 degrees Celsius). In some constructions, the cargo is shipped based on two or more temperatures. For example, tobacco is generally shipped at an initial setpoint temperature of about −4 degrees Fahrenheit (−20 degrees Celsius) to kill a pathogen. The tobacco is then subjected to increased setpoint temperatures to bring the temperature of the tobacco to room temperature. There are many beneficial reasons for varying the setpoint temperature of a particular cargo, including killing infectious diseases, resisting chilling injury to the cargo, or extending the shelf life of the cargo.

Each setpoint temperature control parameter 200A operates for a predetermined time interval (e.g., a first predetermined time interval, a second predetermined time interval, etc.). The controller 55 stores the predetermined time intervals in the database. The predetermined time intervals define when and for how long each parameter 200A of the setpoint temperature profile 200 is to regulate the respective environment condition (e.g., temperature) of the cargo space 30. Each setpoint temperature control parameter 200A operates sequentially with respect to the other setpoint temperature control parameters 200A. For example, for the cargo “CHOCOLATE” illustrated in FIG. 6, the first setpoint temperature control parameter 240A controls the temperature of the cargo space 30 before the second setpoint temperature control parameter 240B.

The predetermined time interval for each temperature control parameter 200A may be programmed into the database 105 based on the expected duration that the cargo will be transported (e.g., estimated distance that the transport unit 10 will travel, expected time duration to reach a desired destination, etc.). The predetermined time interval for each parameter 200A may also be programmed based on the requirements or desired characteristics for the cargo. For example, to extend the shelf life of “Chocolate,” the first setpoint temperature control parameter 240A of the cargo space 30 is 77 degree Fahrenheit (25 degree Celsius), and is applied to the cargo space 30 for the first predetermined time interval (e.g., approximately two days). The second setpoint temperature control parameter 240B is applied to the cargo space 30 after the first predetermined time interval expires, and lasts for the second predetermined time interval. In other words, when the first predetermined time interval expires, the controller 55 automatically adjusts the conditions of the cargo space by initiating the second setpoint temperature control parameter 240B. For the cargo “CHOCOLATE” illustrated in FIG. 6, the second setpoint temperature control parameter 240B is approximately room temperature. The controller 55 applies the second setpoint temperature control parameter 240B to the cargo space 30 for the second predetermined time interval (e.g., the remainder of the duration of the voyage). By automatically adjusting the setpoint temperature control parameter 200A, the expected shelf life of the chocolate, in this example, may be increased by six months.

The environment profile set 190A also includes the acceptable temperature range profile 205 and the humidity profile 210. The acceptable temperature range profile 205 illustrated in FIG. 6 has multiple predetermined acceptable temperature range control parameters 205A that specify the predetermined temperature ranges allowed for each setpoint temperature control parameter 200A. Some kinds of cargo, such as oranges, can be shipped within a relatively wide temperature range. On the other hand, other kinds of cargo (e.g., chocolate, bananas, etc.) may be sensitive to relatively small temperature variations and thus necessitate that the temperature be controlled within a relatively narrow temperature range. Generally, the predetermined temperature range is based on the setpoint temperature control parameter 200A for the particular cargo 195. Similarly, the humidity profile 210 has multiple humidity control parameters 210A that vary the humidity of the cargo space 30 based on the type of cargo 195 being transported.

The acceptable temperature range profile 205 and the humidity profile 210 for “Chocolate,” as well as other environment profiles shown in FIG. 5 and discussed below, may have similar stored data to that described above for the setpoint temperature profile 200. For example, each environment profile may have respective multiple environment control parameters and predetermined time intervals. The predetermined time interval(s) for each environment profile can be the same or different from the predetermined time interval(s) for the other environment profiles.

FIG. 5 illustrates other environmental profiles for various kinds of cargo. For example, the cargo “BANANAS” includes an acceptable time-out-of-range profile 215 that has a plurality of predetermined time-out-of-range control parameters. The plurality of time-out-of-range control parameters define the amount of time the temperature of the cargo space 30 can be outside the acceptable temperature range without the cargo becoming damaged. For some kinds of cargo, the refrigeration system 60 operates substantially continuously, while fuel-conserving start-and-stop operation of the refrigeration system 60 may be acceptable for other kinds of cargo. The cargo “BANANAS” also includes a mode of operation profile 220 that has a plurality of mode of operation control parameters to vary operation of the refrigeration system 60 during transport of the cargo and a setpoint temperature profile 201.

Some kinds of cargo (e.g., “FLOWERS”) may include light profiles 225 that have a plurality of light control parameters (e.g., varying light levels, different light intensities, etc.). In some constructions, a particular cargo may include an atmosphere profile 230 to regulate atmospheric conditions (e.g., a regulated percentage or partial pressure of carbon dioxide, oxygen, ethylene or inert gas, etc.). The atmosphere profile 230 can include a plurality of atmospheric control parameters that provide varying percentages of pressure, or partial pressures, to regulate the associated environment condition within the cargo space 30. Another environment profile that may be associated with one or more kinds of cargo may include a defrost constraints profile 235 that has one or more defrost constraints control parameters.

Some kinds of cargo may not necessarily require each environment profile shown in FIG. 5. For example, the light profile 225 may be an unimportant factor when the cargo is fish, and thus there may be no light profile 225 stored in database for the cargo “Fish.” However, the light profile 225 may be a very important factor when the cargo is flowers, and a light profile 225 may be stored in the database 105 as a function of the cargo “Flowers.” As another example, the atmospheric profile 230 is generally an unimportant factor when the cargo is a frozen food and an important factor for some kinds of fruit.

As illustrated in FIG. 5, some kinds of cargo 195 include environment profiles (e.g., setpoint temperature profile 200) that can be similar or different from environment profiles (e.g., setpoint temperature profile 201, 202) of other kinds of cargo 195. Generally, the setpoint temperature control parameters are defined by the kind of cargo to which the parameter is associated.

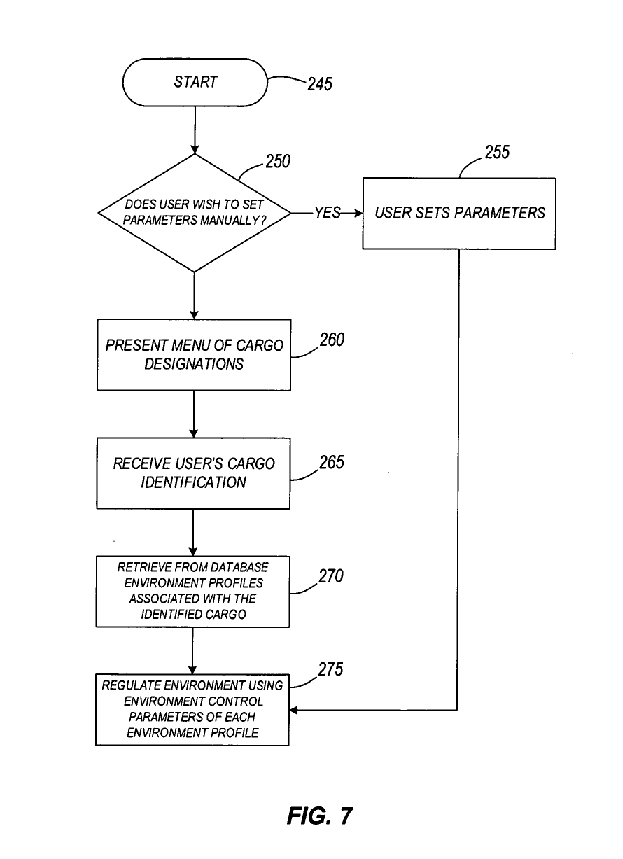

FIG. 7 illustrates the selection process for the environment profiles of the identified cargo stored in the transport unit 10. At step 245, the plurality of environment profile sets 190 for the various cargoes 195 have been stored in the database. If the user would like to set the environment control parameters for the identified cargo 195 manually, then the user invokes this option at step 250. In other embodiments, the user is not allowed the option of manually setting the environmental control parameters. In the illustrated embodiment, the user is presented cargo options 140 at step 260 via the menu 145 from the screen 90 (FIG. 3) of the control unit 40. In other constructions, the user may be present the menu 145 from the screen 170 illustrated in FIG. 4. The user scans the menu 145 for the cargo option that represents the cargo inside the cargo space 30 of the transport unit 10, and selects the cargo option using the cargo selection area 165. The controller receives the identified cargo 195 (i.e., the cargo identified by selection area 165) at step 265 and retrieves the environment profiles at step 270 as a function of the identified cargo from the database 105. Each environment profile has one or more environment control parameters. At step 275, the controller 55 regulates the environment adjusting system 45 according to the environment control parameters retrieved from the database 105. The environment adjusting system 45 varies the environment conditions of the cargo space 30 according to the retrieved profile and respective parameters.

The environment control assembly 32 allows automatic control of environment control parameters for a particular kind of cargo 195 during transportation of the cargo 195. For example, when the user is presented the menu 145 at step 260 and identifies the cargo type (e.g. “Chocolate”), the controller 55 automatically retrieves the setpoint temperature profile 200, the acceptable temperature range profile 205 and the humidity profile 210 from the database 105 of the memory 100 at step 270. The setpoint temperature profile 200 has setpoint temperature control parameters 200A that are used by the environment adjusting system 45 to automatically adjust the temperature of the cargo space 30. The environment adjusting system 45 reduces or increases the temperature of the cargo space 30 in stages (step 275). The stages are defined by the setpoint temperature control parameters 200A. The length at which each stage (i.e., each setpoint temperature control parameter 200A) is operated is equivalent to the length of the programmed predetermined time intervals as set forth above as a function of the voyage or characteristics of the cargo.

In another example of the selection process illustrated in FIG. 7, the transport unit 10 is to store and haul bananas, a cargo which is temperature-sensitive, and the user, such as a truck driver, is required to present parameters to the environment adjusting system 45. The user is able to scan the menu 145 of cargo options 140 (step 260) presented on the display screen 90 (FIG. 3). Using the keypad 95, the user can scroll through the menu 145 to find the word “Bananas” and then select the cargo option “Bananas” from the menu 145. The controller 55 receives the user's cargo identification (step 265), searches for “Bananas” in the database 105 and retrieves environment profiles (step 270) related to bananas from the database 105 (FIG. 5). The truck driver is not required to have prior knowledge of the control parameters for bananas.

In some constructions, the environment control parameters of a particular environment profile can be set manually to specify the varying environment conditions. When the user wishes to set environment control parameters (step 245), the user may be presented the option of setting the parameters manually at step 250 and the user may choose to do so by manually entering the parameters at step 255. In many cases, setting the parameters manually is time-consuming. Setting the environment control parameters manually can also be unreliable, because many users may not know the optimal settings for the cargo being hauled.

Each environment profile has environment control parameters that regulate the environment conditions of the cargo space 30. For example, the bananas are transported at a cool temperature (i.e., a first setpoint temperature) and then heated to room temperature (i.e., a second setpoint temperature) slowly near the end of the transport. One of the environment profiles retrieved from the database 105 includes the setpoint temperature profile 200. The first setpoint temperature control parameter 240A of the profile 200 is delivered to the environment adjusting system and regulates the temperature of the cargo space 30 to 54 degree Fahrenheit (12 degree Celsius) for a first predetermined time interval. At the end of the first predetermined time interval, the second setpoint temperature control parameter 240B and eventually the remaining setpoint temperature control parameters are applied to the cargo space 30 for respective time intervals. Each subsequent setpoint temperature control parameter 200A instructs the environment adjusting system 45 to increase the temperature of the cargo space automatically. Similarly, the parameters of the acceptable time out of range profile 215 and the mode of operation profile 220 for bananas are delivered to the environment adjusting system 45 based on the identified cargo and, without human interference, regulate respective environment conditions of the cargo space 30.

In some constructions, the user also may identify the cargo within the cargo space 30 as being a “Hot” product that must be slowly cooled to avoid chill damages. In this situation, the setpoint temperature profile 200 of the identified cargo may have multiple setpoint temperature control parameters 200A that automatically slowly cool the cargo space 30.

The environment control system 35 may be customized for various transport units 10. In some constructions, for example, the transport units may haul very few kinds of cargo. For these transport units, abbreviated on-board databases 105 may best suit the requirements of the transport units. In other constructions, the information in a remote database 120 may be downloaded in whole or in part to the database 105. Data stored in the database 105 may also be downloaded from one or more of the external access modules (e.g., the hand-held device 125, etc.). For example, cargo can be identified away from the transport unit 10 via the communication connections 118, such as from the cab 130, the office 135, and/or the hand-held device 125.

In other constructions, the cargo space 30 of the transport unit 10 is compartmentalized, creating one compartment for one type of cargo (such as frozen food) and another compartment for another type of cargo (such as produce). Each compartment may be controlled independently of the next. In such cases a single control unit 40 of the environment control system 35 can be adapted to regulate multiple refrigeration systems 60 severing multiple compartments. In other constructions, the system 35 may be programmed to take factors such as geographical area or intended route into consideration to accommodate transport units that operate in different climates or at different altitudes. The environment adjusting system 35 may be configured to prompt the user to supply such geographical information. Other companies may prefer to prompt the user to input data pertaining to security, safety or quality, such as a password or identification code or an acknowledgement from the driver that the correct cargo has been loaded.

In other constructions, a default menu and a default list of cargo products with default environment profiles and environment control parameters may be provided with the control unit 40. At a later time, each individual transport unit may be customized with respect to their environment control system 35 to accommodate to the particular needs of the cargo to be stored in the transport unit.

The illustrated embodiment is described using time intervals between sequential control parameters (e.g., temperature setpoints); however, in other constructions, other predetermined intervals can be used. For example, a product simulator can be packed within the containers (e.g., boxes, crates, pallets, etc.) that are used to package the cargo. The product simulator senses a temperature representative of the temperature of the cargo, as opposed to the temperature within the cargo space 30. If bananas, for example, having a cargo temperature of 80 degrees are loaded onto a transport unit 10 that has a cargo space temperature of 40 degrees, the sensors 50 within the cargo space 30 may sense the temperature to be 40 degrees, but the product simulator may sense the bananas to be 80 degrees. If the setpoint for the bananas is 40 degrees, regulating the temperature of the cargo space 30 based on the sensed temperature from the sensors 50 may take quite a bit of time to drop the temperature of the bananas to 40 degrees. In such an embodiment, the controller 55 can use the sensed temperatures of the product simulator to regulate the temperature of the cargo space 30. When the product simulator reaches a certain temperature (e.g., when the bananas drop to 50 degrees or all the way to 40 degrees), then the controller 55 can switch to the sequential control parameters and intervals.

Various features and advantages of the invention are set forth in the following claims.

What is claimed is:

1. An environment control system for a transport unit defining a cargo space, the environment control system comprising:
a controller in communication with a user interface such that the user interface identifies to the controller one kind of cargo within the cargo space;
an environment adjusting system in communication with the controller and operable to regulate environment conditions inside the cargo space; and
a database in communication with the controller for storing an environment profile as a function of the one kind of cargo such that the environment profile includes a plurality of environment control parameters, each environment control parameter controls the environmental adjusting system for a respective predetermined interval,
wherein the controller retrieves the environment profile for the one kind of cargo from the database based on the identified cargo communicated to the controller and delivers the plurality of environment control parameters of the environment profile to the environment adjusting system, and
wherein the environment adjusting system is configured to then regulate one of the environment conditions inside the cargo space based on each environment control parameter received from the controller such that the environment control parameters control the environment adjusting system sequentially of one another based on the predetermined intervals.

2. The environment control system of claim 1 wherein the environment adjusting system is operable to regulate environment conditions inside a plurality of compartments within the cargo space, wherein each compartment includes one of a plurality of cargoes.

3. The environment control system of claim 2, wherein the user interface identifies to the controller each one of the plurality of cargoes, and the database stores at least one environment profile as a function of each of the plurality of cargoes.

4. The environment control system of claim 1, wherein the database stores a plurality of environment profiles as a function of one kind of cargo and the plurality of environment profiles with respective pluralities of environment control parameters are configured to regulate respective environment conditions inside the cargo space.

5. The environment control system of claim 1, wherein the user interface includes a selectable menu of different kinds of cargo.

6. The environment control system of claim 1, wherein the predetermined interval is a predetermined time interval.

7. The environment control system of claim 6, wherein the database stores the predetermined time interval for each environment control parameter.

8. The environment control system of claim 6, wherein the predetermined time intervals are stored in the database as a function of a voyage of the transport unit.

9. The environment control system of claim 6, wherein the user interface allows the predetermined time interval to be manually entered for each environment control parameter.

10. The environment control system of claim 1 and further comprising a sensor in communication with the controller and operable to sense at least one of the environment conditions inside the cargo space.

11. A method for transporting cargo in a cargo space within a transport unit, the method comprising the steps of:
providing a controller coupled to an environment adjusting system;
identifying the cargo to the controller;
identifying an environment profile associated with the cargo, the environment profile defining a plurality of environment control parameters for regulating one environment condition as a function of the cargo;
sensing an environment condition within the cargo space;
comparing the sensed environment condition with one of the desired environment control parameters provided by the environment profile;
modifying the environment condition with the environment adjusting system to achieve the one desired environment control parameter;
comparing the sensed environment condition with another one of the desired environment control parameters provided by the environment profile after a predetermined interval; and
modifying the environment condition with the environment adjusting system from the one desired environment control parameter to another one of the desired environment control parameters.

12. The method of claim 11, wherein identifying the cargo to the controller includes identifying the cargo to the controller with a user interface.

13. The method of claim 11, wherein sensing an environment condition within the cargo space includes sensing environment conditions within respective compartments of the cargo space.

14. The method of claim 11, further comprising providing a menu of potential kinds of cargo, and permitting an operator to select one kind of cargo from the menu.

15. The method of claim 11, further comprising providing a database and storing the environment profile within the database as a function of the one kind of cargo.

16. The method of claim 15, further comprising permitting the controller to identify the environment profile within the database.

17. The method of claim 11, further comprising identifying a plurality of environment profiles associated with the one kind of cargo, the plurality of environment profiles for regulating a plurality of environment conditions inside the cargo space with the one kind of cargo.

18. The method of claim 11, further comprising regulating the one environment condition to each environment control parameter with the environment adjusting system.

19. The method of claim 11, further comprising delivering each environment control parameter from the controller to the environment adjusting system.

20. The method of claim 11, further comprising providing the predetermined interval as a predetermined time interval.
